(19) United States
(12) Patent Application Publication
(10) Pub. No.: US 2026/0133518 A1
(43) Pub. Date: May 14, 2026

(54) MAGNETIC ONE-COMPONENT TONER AND IMAGE FORMING APPARATUS USING THE SAME

(71) Applicant: KYOCERA Document Solutions Inc., Osaka (JP)

(72) Inventor: Kento FURUTA, Osaka (JP)

(73) Assignee: KYOCERA Document Solutions Inc., Osaka (JP)

(21) Appl. No.: 19/382,499

(22) Filed: Nov. 7, 2025

(30) Foreign Application Priority Data
Nov. 14, 2024 (JP) 2024-199256

(51) Int. Cl. G03G 9/093; G03G 9/083; G03G 9/087; G03G 15/09

(52) U.S. Cl. CPC G03G 9/09342; G03G 9/0838; G03G 9/08755; G03G 15/0914; G03G 2215/0619

(57) ABSTRACT

Magnetic one-component toner includes a toner particle having a toner base particle and an external additive attached to the surface of the toner base particle. The toner base particle contains at least a binder resin and a magnetic powder. The external additive contains a wet silica particle and a conductive inorganic particle. The wet silica particle has its surface treated with a hydrophobization agent comprising a long-chain fatty acid ester with a carbon number of at least 18 or more. The conductive inorganic particle has a hydrophobized surface. The volume resistivity of the wet silica particle is 1.0E+7 [Ω·cm] or more but 1.0E+10 [Ω·cm] or less.

### INCORPORATION BY REFERENCE

This application is based on and claims the benefit of priority from Japanese Patent Application No. 2024-199256 filed on Nov. 14, 2024, the contents of which are hereby incorporated by reference.

### BACKGROUND

The present disclosure relates to magnetic one-component toner and an image forming apparatus of a magnetic one-component development type using magnetic one-component toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image.

Known methods for developing the electrostatic latent image with toner include: magnetic one-component development, which uses only magnetic toner; and two-component development, which uses two-component developer containing non-magnetic toner and magnetic carrier. Since magnetic toner is inexpensive compared with two-component developer, magnetic one-component development is commonly used in monochrome printers.

In magnetic one-component development, a high electric resistance of toner leads to poor charge propagation across toner chains and thus a broad charge amount distribution of toner. This degrades development properties. This can be coped with by reducing the electric resistance of toner.

### SUMMARY

According to one aspect of the present disclosure, magnetic one-component toner includes a toner particle having a toner base particle and an external additive attached to the surface of the toner base particle. The toner base particle contains at least a binder resin and a magnetic powder. The external additive contains a wet silica particle and a conductive inorganic particle. The wet silica particle has its surface treated with a hydrophobization agent comprising a long-chain fatty acid ester with a carbon number of at least 18 or more. The conductive inorganic particle has a hydrophobized surface. The volume resistivity of the wet silica particle is 1.0E+7 [Ω·cm] or more but 1.0E+10 [Ω·cm] or less.

### BRIEF DESCRIPTION OF THE DRAWING

FIG. 1 is a schematic sectional view of an image forming apparatus that uses magnetic one-component toner according to the present disclosure.

### DETAILED DESCRIPTION

### [1. Overall Configuration of Image Forming Apparatus]

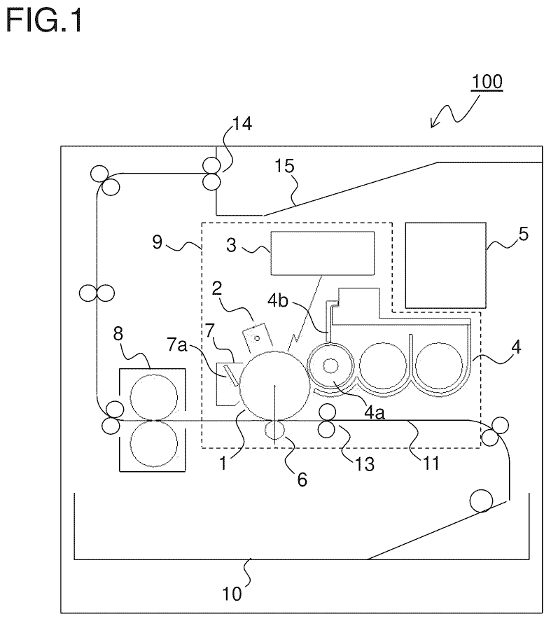

Hereinafter, an embodiment of the present disclosure will be described with reference to the accompanying drawing. FIG. 1 is a schematic sectional view of an image forming apparatus 100 in which magnetic one-component toner according to the present disclosure is used. In the image forming apparatus (e.g., a monochrome printer) 100, when a printing operation is performed, in an image forming portion 9 inside the image forming apparatus 100, an electrostatic latent image is formed based on original-image data received from a host device (not shown) such as a personal computer or the like, and a developing device 4 attaches toner to the electrostatic latent image to form a toner image. Toner is supplied to the developing device 4 from a toner container 5. In the image forming apparatus 100, while rotating a photosensitive drum 1 in a clockwise direction in FIG. 1, the image forming process is executed with respect to the photosensitive drum 1.

The image forming portion 9 includes, arranged along the rotation direction of the photosensitive drum 1 (the clockwise direction), a charging device 2, an exposure unit 3, the developing device 4, a transfer roller 6, a cleaning device 7, and a charge eliminating device (not shown). The photosensitive drum 1 is formed by laying a photosensitive layer on the surface (outer circumferential surface) of an aluminum drum, for example. The surface (outer circumferential surface) of the photosensitive drum 1 is uniformly charged by the charging device 2. Then, on the surface irradiated with a light beam from the exposure unit 3, which will be described later, an electrostatic latent image is formed through attenuation of electric charge. Although the photosensitive layer is not particularly limited in material, it is preferably formed of amorphous silicon (a-Si), for example, for its excellent durability. The linear velocity of the photosensitive drum 1 (i.e., the process linear velocity of the image forming apparatus 100) is 330 mm/sec or more.

The charging device 2 uniformly charges the surface of the photosensitive drum 1. Used as the charging device 2 is, for example, a corona discharge device that produces electric discharge by applying a high voltage to an electrode such as a piece of fine wire. Instead of a corona discharge device, there may be employed a contact-type charging device that achieves voltage application while a charging member, as exemplified by a charging roller, is in contact with the surface of the photosensitive drum 1. The exposure unit 3 irradiates the photosensitive drum 1 with a light beam (for example, a laser beam) according to image data and thereby forms an electrostatic latent image on the surface of the photosensitive drum 1.

The developing device 4 attaches toner to the electrostatic latent image on the photosensitive drum 1 to form a toner image. In the embodiment, magnetic one-component toner (magnetic one-component developer) is stored in the developing device 4. The developing device 4 employs a magnetic one-component jumping development method and includes a mechanism that has a non-contact regulation blade 4b for a development roller 4a and that electrostatically charges toner via the development roller 4a. The cleaning device 7 includes a cleaning blade 7a in line contact with the photosensitive drum 1 in its longitudinal direction (i.e., direction perpendicular to the plane of FIG. 1), and the cleaning blade 7a removes residual toner remaining on the surface of the photosensitive drum 1 after the toner image has been moved (transferred) onto a sheet.

Toward the photosensitive drum 1, on which the toner image has been formed in the above-described manner, a sheet is conveyed at a predetermined timing from a sheet storage portion 10 via a sheet conveyance path 11 and a registration roller pair 13 to the image forming portion 9. The transfer roller 6 is in contact with the photosensitive drum 1, thereby forming a nip portion (a transfer nip portion), and moves (transfers) the toner image having been formed on the surface of the photosensitive drum 1 onto the sheet passing through the transfer nip portion without image distortion. After that, in preparation for subsequent formation of a new electrostatic latent image, residual toner left on the surface of the photosensitive drum 1 are removed by the cleaning device 7, and residual charge is eliminated by the charge eliminating device.

The sheet, onto which the toner image has been transferred, is separated from the photosensitive drum 1 to be conveyed to the fixing device 8, where heat and pressure are applied to the sheet to fix the toner image onto the sheet. The sheet having passed through the fixing device 8 is ejected via an ejection roller pair 14 to a sheet ejection portion 15.

### [2. Basic Configuration of Toner]

A description will be given below of the magnetic one-component toner according to the present disclosure (hereinafter also referred to simply as the toner) used in the image forming apparatus 100. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750” manufactured by HORIBA, Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂═C(CH₃)—CO—) collectively.

Toner according to the embodiment can be used as positively chargeable toner suitably for development of electrostatic latent images. The toner according to the embodiment is a powdery substance containing a plurality of toner particles (each a particle configured as described later). The toner contains a magnetic powder and is used as one-component developer.

The toner particles of the toner according to the embodiment have a toner base particle and an external additive attached to the surface of the toner base particle. The toner base particle contains at least a binder resin and a magnetic powder. As necessary, the toner base particle can contain, in the binder resin, a colorant, a release agent, a charge control agent, and the like. In the toner according to the present disclosure, as the external additive, silica particles and conductive inorganic particles are externally added to the surface of the toner base particle.

Used as the silica particles externally added to the toner according to the present disclosure is silica particles produced in a liquid phase (wet silica particles). The surface of the wet silica particle is hydrophobized using a hydrophobization agent comprising a long-chain fatty acid ester with a carbon number of at least 18 or more.

Preferred as the conductive inorganic particles externally added to the toner according to the present disclosure is one or more types selected from alumina, titanium oxide, strontium titanate, and barium titanate. In addition, in magnetic one-component jumping development, a large charge amount of the toner base particle leads to stable charging of toner. Presence of conductive inorganic particles with high conductivity on the surface of the toner base particle acts to make the charge among toner particles even. Thus, by externally adding the conductive inorganic particles to the surface of the toner base particle, it is possible to obtain very stable image quality.

With the toner according to the present disclosure, externally adding the above-described wet silica particles and conductive inorganic particles to the toner base particle helps sufficiently lower the resistance of the toner particles. This enhances charge propagation across toner chains and provides a charge amount distribution maintained in a given range. Thus, the toner according to the present disclosure can be particularly suitably used in an image forming apparatus 100 like the one shown in FIG. 1 employing the magnetic one-component jumping development method.

### [3. Material of Toner]

Now, a description will be given, one by one, of the binder resin, the magnetic powder, a release agent, the charge control agent that form the toner base particle, the external additives externally added to the toner base particle, and a method for producing the toner according to the present disclosure.

### (Binder Resin)

The toner base particle that forms the toner according to the present disclosure contains a binder resin. The binder resin that can be contained in the toner base particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties on sheets, preferably, at least one of a polyester resin and a styrene-acrylic-based resin is used, more preferred being a polyester resin. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester resin, the softening point of the polyester resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tends to be poor. If the glass transition point is too low, the heat-resistant preservation properties of the toner tends to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.), as a measuring instrument. 10 mg of a measurement sample is put in an aluminum pan while an empty aluminum pan is used as a reference. From the endothermic curve of the binder resin plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Magnetic Powder)

The toner base particle contains a magnetic powder in the binder resin. Examples of the material of the magnetic powder include: a magnetic iron oxide or a compound of a divalent metal with an iron oxide, such as magnetite, maghemite, and ferrite; a powder of a metal such as iron, cobalt, or nickel or of an alloy of any of these metals with a metal such as aluminum, cobalt, copper, lead, magnesium, tin, zinc, antimony, beryllium, bismuth, cadmium, calcium, manganese, selenium, titanium, tungsten, or vanadium; or a mixture of any of those powdery substances.

The particle size of the magnetic powder is not limited within the scope consistent with the object of the present disclosure. Specifically, the particle size of the magnetic powder is preferably 0.05 to 2.0 μm, and more preferably 0.1 μm or more but 1.0 μm or less. Using a magnetic powder with a particle size in those ranges makes it easy to disperse the magnetic powder uniformly in the binder resin.

As the magnetic powder, it is possible to use a product surface-treated using a surface treatment agent such as a titanium-based coupling agent or silane-based coupling agent for the purpose of improving the dispersion properties of the magnetic powder in the binder resin.

The amount of magnetic powder used is not particularly limited within the scope consistent with the object of the present disclosure. Specifically, the amount of magnetic powder used is preferably, relative to 100 mass parts of the binder resin, approximately 10 to 150 mass parts, and more preferably 30 mass parts or more but 60 mass parts or less. Using too large an amount of magnetic powder can make it difficult to form images with the desired image density for a long period, or can lead to extremely poor fixing properties of the toner to sheets. Using too small an amount of magnetic powder can cause fogging in the formed image, or can make it difficult to form images with the desired image density for a long period.

### (Release Agent)

For the purpose of improving its fixing properties and offset resistance, the toner base particle can contain a release agent. The type of release agent that can be contained in the toner base particle is not particularly limited. As the release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding these release agents to the toner base particle helps more efficiently suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax C1 (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner base particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of toner.

### (Colorant)

Containing a magnetic powder as an essential component, the toner base particle is generally black. Accordingly, within the scope consistent with the object of the present disclosure, for the purpose of obtaining a more preferred tone of black in the image formed using the toner according to the present disclosure, the toner can contain as a colorant any known dye or pigment. Specifically, one example of a pigment is carbon black and one example of a dye is an acid violet.

The amount of colorant used is not particularly limited within the scope consistent with the object of the present disclosure. Specifically, the amount of colorant used is preferably, relative to the total mass of the toner base particle, 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner base particle can contain a charge control agent for the purpose of improving the charge level of the toner and its charge response properties as an index of whether it can be charged to a predetermined charge level in a short time and thereby obtaining toner with excellent durability and stability. Since the toner according to the present disclosure is positively chargeable toner, a positively chargeable charge control agent is used.

The type of charge control agent that can be contained in the toner base particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; triphenylmethane-based dyes; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The toner base particle can be a toner base particle with no shell layer (non-capsule toner base particle) or a toner base particle with a shell layer (capsule toner base particle). A capsule toner base particle can be produced by forming a shell layer on the surface of a non-capsule toner base particle (toner core particle). The shell layer can be formed substantially solely of a thermosetting resin, can be formed substantially solely of a thermoplastic resin, or can contain both a thermoplastic resin and a thermosetting resin.

### (External Additive)

The toner according to the present disclosure has a toner base particle of which the surface is treated with an external additive. The toner according to the present disclosure contains, as the external additive, wet silica particles and metal fine particles.

### (Wet Silica Particles)

Wet silica particles are produced, for example, by a method that synthesizes silica fine particles in wet form through hydrolysis of an alkoxysilane or a method like a precipitation process or a sol-gel process that produces silica fine particles in wet form from sodium silicate.

The wet silica particle used in the toner according to the present disclosure has its surface treated (coated) with a hydrophobization agent comprising a long-chain fatty acid ester with a carbon number of at least 18 or more. Examples of hydrophobization agents comprising a long-chain fatty acid ester include titanate-based coupling agents such as isopropyltriisostearoyl titanate.

Introducing a positively chargeable polar group on the surface of the wet silica particle helps enhance the positive chargeability of the toner. Preferred as a method for introducing a positively chargeable polar group on the wet silica particles is treating the surface of the wet silica particle using a positively chargeable surface treatment agent having a positively chargeable polar group. Examples of positively chargeable surface treatment agents include silane coupling agents having a positively chargeable polar group such as an amino group.

The average particle size of the wet silica particle is preferably 10 nm or more but 150 nm or less. The amount of wet silica particles added is preferably, relative to the mass of the toner base particle, 0.2 mass % or more but 0.4 mass % or less, and more preferably 0.2 mass % or more but 0.3 mass % or less. Keeping the amount of wet silica particles added in those ranges, among others, makes it easy to suppress fogging in images resulting from the toner receiving mechanical stress in a developer container. It is then also easy to obtain toner of which the rate of change of the fluidity is 5% or less.

The volume resistivity of the wet silica particle used in the toner according to the present disclosure is 10E+7 [Ω·cm] or more but 10E+10 [Ω·cm] or less. Too low a volume resistivity of the wet silica leads to a low charge amount of the toner, and thus a low responsiveness of the toner to an electric field, resulting in low image density. On the other hand, too high a volume resistivity of the wet silica leads to a high charge amount of the toner and a strong electrostatic adhesion force, and thus difficulty in developing with the toner, resulting in a low image density. Preferably, the primary particle size of the wet silica particle is 10 nm or more but 100 nm or less. Preferably, the amount of wet silica particles added is, relative to the total mass of the toner particle (the toner base particles and external additives), 0.1 to 0.3 mass %.

### (Conductive Inorganic Particles)

As the conductive inorganic particle used in the toner according to the present disclosure, particles of a metal oxide can be used. Specific examples of metal oxides include alumina, titanium oxide, magnesium oxide, zinc oxide, strontium titanate, barium titanate, antimony trioxide (ATO), indium tin oxide (ITO), and the like. Particularly preferred are one or more selected from alumina, titanium oxide, strontium titanate, and barium titanate.

The conductive inorganic particle used in the toner according to the present disclosure has its surface modified using a hydrophobization agent (i.e., hydrophobized). Hydrophobizing the surface of the conductive inorganic particle helps increase the surface electric resistance of the toner particle and suppress the leakage of electric charge from the electrostatically charged toner.

Usable as the hydrophobization agent for the conductive inorganic particles are silicon-containing organic compounds (alkoxysilane compounds, silazane compounds, silicone oil, and the like) such as silane coupling agents, titanate-based coupling agents such as isopropyltriisostearoyl titanate, organic fluorine compounds, organic fatty acids, and the like.

Preferably, the volume resistivity of the conductive inorganic particle used in the toner according to the present disclosure is 1.0E+3 [Ω·cm] or less. The primary particle size of the conductive inorganic particle is preferably 200 nm or more but 400 nm or less. Preferably, the amount of conductive inorganic particles added is, relative to the total mass of the toner particle (the toner base particle and external additives), 1.0 to 1.5 mass %.

In addition to the wet silica particles and the conductive inorganic particles described above, any other external additive can be added within a range consistent with the object of the present disclosure. The types of external additive that can be added are not particularly limited and thus any of external additives known to be used in toner can be appropriately selected. Specific examples of suitable external additives include silica particles with a non-hydrophobized surface, resin particles, and the like.

### [4. Production Method for Toner]

Next, a production method for the toner according to the present disclosure will be described. The production method for the toner includes a production method for a toner base particle and an external additive treatment method for attaching an external additive to the surface of the toner base particle. The production method for the toner base particle is not particularly limited so long as it forms the toner base particle with a predetermined structure. A toner base particle coated with a shell layer can be used as needed. As a production method suitable for the positively chargeable toner described above, a production method for the toner base particle and an external additive treatment method will be described one by one.

### (Production Method for Toner Base Particle)

The method for producing the toner base particle is not particularly limited so long as it can satisfactorily disperse a magnetic powder and any components such as a release agent, a colorant, and a charge control agent in the binder resin. Examples of suitable production methods for the toner base particle include a pulverization method and an agglomeration method.

In a pulverization method, the binder resin is mixed with the components such as the magnetic powder, colorant, release agent, and charge control agent using a mixer or the like; then the binder resin and the components blended in it are melted and kneaded using a kneader such as a uniaxial or biaxial extruder; and then the cooled kneaded product is pulverized and classified. The average particle size of the toner base particle is not particularly limited within the scope consistent with the object of the present disclosure; typically, it is preferably 5 μm or more but 10 μm or less.

In an agglomeration method, in an aqueous solvent containing fine particles of each of the binder resin, magnetic powder, colorant, release agent, charge control agent, and the like, those fine particles are agglomerated until they form particles of the desired particle size. This produces agglomerated particles containing the binder resin, release agent, charge control agent, and colorant. Subsequently, the obtained agglomerated particles are heated so that the components of the agglomerated particles coalesce. In this way, a toner base particle with the desired particle size is obtained.

### (External Additive Treatment Method)

The method for treating the toner base particle with the external additive is not particularly limited; the toner base particle can be treated by any known method. Specifically, the toner base particle is treated with the external additive using a mixer such as a Turbula mixer, a Henschel mixer, a Nauta mixer, or a V-shape mixer under treatment conditions adjusted so that the particles of the external additive do not sink into the toner base particle.

With the toner according to the present disclosure described above, when images are formed for a long period in various environment such as a high-temperature high-humidity environment and a low-temperature low-humidity environment, it is possible to stabilize the charge amount of the toner, and thus to form images with the desired density. It is also possible to effectively suppress image fogging after durability printing. Thus, the toner according to the present disclosure can be used suitably in various image forming apparatuses. In particular, it is preferable to use the toner according to the present disclosure in an image forming apparatus 100 like the one shown in FIG. 1 that employs a magnetic one-component jumping development method in which the regulation blade 4b stays out of contact with the development roller 4a and the process linear velocity is 330 mm/sec or more, because it is then possible to keep the charge amount distribution of toner in the desired range and suppress degradation of development properties. The effects of the present disclosure will be described more specifically below by way of practical examples. The present disclosure is in no way limited by these practical examples.

### EXAMPLES

### Production Example 1

### (Production of Toner Base Particle)

100 mass parts of a polyester resin (HP-313, manufactured by The Nippon Synthetic Chemical Industry Co., Ltd.) as a binder resin, 4 mass parts of a charge control agent (FCA-201-PS, manufactured by Fujikura Kasei Co., Ltd.), 4 mass parts of carnauba wax (manufactured by TOA KASEI CO., LTD.) as a release agent, and 80 mass parts of a magnetic powder (TN-15, manufactured by Mitsui Mining & Smelting) were mixed using a Henschel mixer (FM-10 model, manufactured by Mitsui Mining & Smelting) to obtain a mixture.

The obtained mixture was melted and kneaded using a biaxial extruder (TEM-26SS, manufactured by Toshiba Machine Co., Ltd.) to obtain a kneaded product. The kneaded product was cooled and was then coarsely pulverized using a pulverizer (Rotoplex, manufactured by Toa Machine Industry). The obtained coarsely pulverized product was then pulverized using an air-flow pulverizer (Turbomill RS model, manufactured by Turbo Industries) to obtain a finely pulverized product. The finely pulverized product was classified using a wind-power classifier (EJ-L-3 (LABO) model, manufactured by NITTETSU MINING) to obtain toner base particles with a volume average primary particle size of 7.0 μm.

### Production Example 2

### (Production of Wet Silica Particles)

In a jacketed reaction vessel of stainless steel with a volume of 2 L provided with a stirrer, two dropping nozzles, and a thermometer as well as with a circulation pump, aqueous solution of sodium silicate No. 3 (SiO₂ concentration: 25 mass %, SiO₂/Na₂O mol ratio: 3.3) and a 40 mass % aqueous solution of sulfuric acid were mixed such that the excess sulfuric acid was 0.6N to obtain silica hydrosol. The silica hydrosol was left to stand still for a while to turn into gel. The product was hydrothermally processed for 12 hours under the conditions of 90° C. and a pH value of 9.5; then, to remove alkalis, sulfuric acid was added until the excess sulfuric acid was 0.03N. The product was then left to stand still for another one hour at 60° C. After that, the product was washed with water sufficiently to obtain pure silica hydrogel. The obtained silica hydrogel was dried using a dryer until its moisture content was 10%, was then pulverized on a jet mill using superheated steam (MJT-1, manufactured by Hosokawa Micron Corporation), and was classified using a wind-power classifier (EJ-L-3 (LABO) model, manufactured by NITTETSU MINING) to obtain wet silica particles. The volume resistivity of the wet silica particles was 2.3E+6 Ω·cm.

To 100 mass parts of the obtained wet silica particles, a solution of, as a hydrophobization agent, 15 mass parts of isopropyltriisostearoyl titanate (KR-TTS, manufactured by Ajinomoto Fine-Techno Co., Inc.) dissolved in 40 mass parts of toluene was added to produce a slurry. The mixed slurry was mixed for two hours using a ball mill and was then dried to obtain wet silica particles with a hydrophobized surface. The volume resistivity of the wet silica particle after hydrophobization was 4.0E+8 Ω·cm.

### Production Example 3

### (Production of Aluminum Oxide Particles)

100 mass parts of aluminum oxide (AKP-30, manufactured by SUMITOMO CHEMICAL COMPANY, LIMITED) were dispersed in 1000 mass parts of water to produce a slurry and the slurry was heated to 70° C. To the slurry, an aqueous solution of 10.5 mass parts of tin chloride pentahydrate dissolved in 100 mass parts of 2N hydrochloric acid, and 6.7N ammonia water were simultaneously dropped for about 40 minutes such that the pH value of the slurry was kept at 7 to 8. Then, a solution of 34.4 mass parts of antimony chloride and 5.3 mass parts of tin chloride pentahydrate in 450 mass parts of 2N hydrochloric acid, and 6.7N ammonia water were simultaneously dropped for about one hour such that the pH value of the slurry was kept at 7 to 8. Subsequently, the slurry was filtered, washed, and dried at 110° C. The product was heat-treated for one hour in a current of nitrogen gas at 1 L/min at 500° C. to obtain aluminum oxide particles (conductive inorganic particles). The volume resistivity of the aluminum oxide particle was 1.22 Ω·cm.

To 50 mass parts of the obtained aluminum oxide particles, as a hydrophobization agent, a solution of 2.5 mass parts of isopropyltriisostearoyl titanate (KR-TTS, manufactured by Ajinomoto Fine-Techno Co., Inc.) dissolved in 40 mass parts of toluene was added to produce a slurry. The mixed slurry was mixed for two hours using a ball mill and was then dried to obtain aluminum oxide particles with a hydrophobized surface.

### (Production of Titanium Oxide Particles)

Titanium oxide particles (conductive inorganic particles) with a hydrophobized surface were obtained through a procedure similar to the one for aluminum oxide particles except that, instead of 100 mass parts of aluminum oxide, 100 mass parts of titanium oxide (JR, manufactured by Tayca Corporation) were used. The volume resistivity of the titanium oxide particle was 55 Ω·cm.

### (Production of Strontium Titanate Particles)

Strontium titanate particles (conductive inorganic particles) with a hydrophobized surface were obtained through a procedure similar to the one for aluminum oxide particles except that, instead of 100 mass parts of aluminum oxide, 100 mass parts of strontium titanate (SW-100, manufactured by Titan Kogyo, Ltd.) were used. The volume resistivity of the strontium titanate particle was 88 Ω·cm.

### (Production of Barium Titanate Particles)

Barium titanate particles (conductive inorganic particles) with a hydrophobized surface were obtained through a procedure similar to the one for aluminum oxide particles except that, instead of 100 mass parts of aluminum oxide, 100 mass parts of barium titanate (BT-S, manufactured by KCM Corporation) were used. The volume resistivity of the barium titanate particle was 72 Ω·cm.

### Production Example 4

### (Production of Toner)

To the toner base particles obtained in production example 1, as an external additive, 0.7 mass % of silica particles with a non-hydrophobized surface (RA200H, manufactured by Nippon AEROSIL CO., LTD.), 0.3 mass % of the wet silica particles obtained in production example 2, and 1 mass % of the aluminum oxide particles obtained in production example 3 were added, and the mixture was mixed for 15 minutes using a Henschel mixer (FM-10 model, manufactured by Mitsui Mining & Smelting) to attach (externally add) the silica particles, wet silica particles, and conductive inorganic particles to the toner base particles. Then, the product was sieved using an electric vibrating sieve (ANF-30, manufactured by NITTO KAGAKU CO., Ltd.), with a 200-mesh sieve (with 75 μm openings) to obtain toner T-1.

Toners T-2 to T-6 were obtained through a procedure similar to the one for toner T-1 except that the added amounts of silica particles with a non-hydrophobized surface (untreated silica particles) and of wet silica particles, and the type and added amount of conductive inorganic particles were changed. Table 1 shows the types and added amounts of silica particles and conductive inorganic particles in toners T-1 to T-6.

TABLE 1

| | Silica Particles | | | |
|---|---|---|---|---|
| | Dry Silica | Wet Silica | Conductive Inorganic Particles | |
| | Particles | Particles | | Added Amount |
| Toner | [mass %] | [mass %] | Base Material | [mass %] |
| T-1 | 0.7 | 0.3 | Aluminum Oxide | 1.0 |
| T-2 | 0.7 | 0.3 | Titanium Oxide | 1.0 |
| T-3 | 0.7 | 0.3 | Strontium Titanate | 1.0 |
| T-4 | 0.7 | 0.3 | Barium Titanate | 1.0 |
| T-5 | 0.7 | 0.3 | — | — |
| T-6 | 1.0 | — | Aluminum Oxide | 1.0 |

### (Measurement of Amount of Nitrogen Element in Toner)

The amount of nitrogen element in the toner was measured using a CHN analyzer (240011, manufactured by PerkinElmer Japan G.K.). With an electric furnace set at 800° C. in a pyrolysis part and at 900° C. in the catalysis part, under the measurement conditions of a main O₂ flow rate of 300 mL/min, an O₂ flow rate of 300 mL/min, and an air flow rate of 400 mL/min, quantitative determination was performed with reference to a standard curve prepared using indomethacin and the like as a standard sample for a standard curve.

### [Evaluation of Image Density and Image Fogging]

For each of toners T-1 to T-4 of Practical Examples 1 to 4 and toners T-5 and T-6 of Comparative Examples 1 and 2, the image density and the image fogging were evaluated by the methods described below.

### (Image Density)

As an evaluation machine, a monochrome printer (ECOSYS PA6000x, manufactured by Kyocera Document Solutions) was used. The toners of Practical Examples 1 to 4 and Comparative Examples 1 and 2 obtained in production example 4 were each installed in a developing portion of the evaluation machine. Toner for supply (the same toner as the toner installed in the developing portion) was also installed in a toner container of the evaluation machine.

After the installation of the toner, in a normal-temperature normal-humidity environment (temperature: 23° C., humidity; 50% RH), continuous image printing was performed on 100,000 sheets at a coverage rate of 5%. An evaluation image including a solid image was printed on one printing sheet once at the start of printing (initial stage) and once after continuous (durability) printing on 100,000 sheets.

The image density (ID) of the evaluation images was measured using a reflection densitometer (RD914, manufactured by GretagMacbeth Ltd.). The evaluation criteria for image density were as follows:

$$\begin{matrix}GOOD : ID \geq 1.3 \\ OK : 12 \leq ID < 1.3 \\ POOR : ID < 1.2\end{matrix}$$

### (Image Fogging)

The fogging density (FD) in a blank part (unprinted part) of the evaluation images was measured using a reflection densimeter (RD914, manufactured by GretagMacbeth Ltd.). The evaluation criteria for image fogging were as follows:

$$\begin{matrix}GOOD : FD \leq 0. 03 \\ OK : 0. 3 < FD \leq 0.007 \\ POOR : FD < 0. 7\end{matrix}$$

Table 2 shows the results of evaluation of image density and image fogging with each of toners T-1 to T-4 of Practical Examples 1 to 4 and toners T-5 and T-6 of Comparative Examples 1 and 2.

TABLE 2

| | | Image Density | | | Image Fogging | | |
|---|---|---|---|---|---|---|---|
| | | At Initial | After | | At Initial | After | |
| | | Stage | Durability | | Stage | Durability | |
| | Toner | [ID] | [ID] | Evaluation | [FD] | [FD] | Evaluation |
| Practical Example 1 | T-1 | 1.37 | 1.35 | GOOD | 0.001 | 0.002 | GOOD |
| Practical Example 2 | T-2 | 1.35 | 1.34 | GOOD | 0.000 | 0.001 | GOOD |
| Practical Example 3 | T-3 | 1.36 | 1.34 | GOOD | 0.000 | 0.002 | GOOD |
| Practical Example 4 | T-4 | 1.35 | 1.31 | GOOD | 0.001 | 0.002 | GOOD |
| Comparative Example 1 | T-5 | 1.34 | 1.19 | POOR | 0.000 | 0.007 | OK |
| Comparative Example 2 | T-6 | 1.35 | 1.26 | OK | 0.000 | 0.010 | POOR |

Table 2 reveals the following. Toners T-1 to T-4 of Practical Examples 1 to 4, in which the toner base particles had externally added to them dry silica particles, wet silica particles hydrophobized using a hydrophobization agent comprising a long-chain fatty acid ester, and conductive inorganic particles with a hydrophobized surface, were all good in both image density and image fogging.

In contrast, toner T-5 of Comparative Example 1, with no external addition of conductive inorganic particles with a hydrophobized surface, was poor in image density after durability printing on 100,000 sheets. In addition, image fogging slightly appeared after durability printing on 100,000 sheets.

Toner T-6 of Comparative Example 2, which was not blended with wet silica particles hydrophobized using a hydrophobization agent comprising a long-chain fatty acid ester, was slightly poor in image density after durability printing on 100,000 sheets, and, after durability printing on 100,000 sheets, marked image fogging appeared.

The above results confirm that externally adding wet silica particles hydrophobized using a hydrophobization agent comprising a long-chain fatty acid ester and conductive inorganic particles with a hydrophobized surface to toner base particles yields magnetic one-component toner that can effectively suppress reduced image density and image fogging after durability printing.

The present disclosure finds application in positively chargeable magnetic one-component toner for use in electrophotography. Based on the present disclosure, it is possible to provide magnetic one-component toner that can improve the blackness of toner and that can stabilize the charge amount of the toner for a long period of time.

What is claimed is:

1. Magnetic one-component toner comprising a toner particle having:
a toner base particle containing at least a binder resin and a magnetic powder; and
an external additive attached to a surface of the toner base particle,
wherein
the external additive contains:
a wet silica particle with a surface thereof hydrophobized using a hydrophobization agent comprising a long-chain fatty acid ester with a carbon number of at least 18 or more; and
a conductive inorganic particle with a hydrophobized surface, and
a volume resistivity of the wet silica particle is 1.0E+7 [Ω·cm] or more but 1.0E+10 [Ω·cm] or less.

2. The magnetic one-component toner according to claim 1, wherein
the conductive inorganic particle is one or more types selected from an aluminum oxide particle, a titanium oxide particle, a strontium titanate particle, and a barium titanate particle.

3. The magnetic one-component toner according to claim 1, wherein
the hydrophobization agent comprising the long-chain fatty acid ester is isopropyltriisostearoyl titanate and an added amount of the isopropyltriisostearoyl titanate is, relative to the wet silica particle, 5 mass % or more but 20 mass % or less.

4. The magnetic one-component toner according to claim 1, wherein
the external additive further contains a silica particle with a non-hydrophobized surface.

5. An image forming apparatus comprising:
a developing device that, using the magnetic one-component toner according to claim 1, develops an electrostatic latent image formed on an image carrying member into a toner image; and
a transferring device that transfers the toner image developed by the developing device to a recording medium,
wherein
the developing device employs a magnetic one-component jumping development method in which the magnetic one-component toner is electrostatically charged via a toner carrying member that carries the magnetic one-component toner, and
a linear velocity of the image carrying member is 330 mm/sec or more.
